(19) United States
(12) Patent Application Publication
(10) Pub. No.: US 2025/0200181 A1
(43) Pub. Date: Jun. 19, 2025

(54) DATA BACKUP METHOD, APPARATUS, AND SYSTEM

(71) Applicant: HUAWEI TECHNOLOGIES CO., LTD., Shenzhen (CN)

(72) Inventor: Shufeng YI, Beijing (CN)

(73) Assignee: HUAWEI TECHNOLOGIES CO., LTD., Shenzhen, GD (CN)

(21) Appl. No.: 18/977,528

(22) Filed: Dec. 11, 2024

(30) Foreign Application Priority Data
Dec. 13, 2023 (CN) 202311715008.1

(51) Int. Cl. G06F 21/56; G06F 11/14

(52) U.S. Cl. CPC G06F 21/568; G06F 11/1451; G06F 21/564

(57) ABSTRACT

A data backup method, an apparatus, and a system. If an input/output (I/O) command for a file system of a computer device instructs to perform a modification operation on an existing file in the file system, the computer device first performs a data backup procedure on the existing file, and then modifies the existing file according to the I/O command. The data backup procedure includes: determining whether a target process initiating the I/O command is a trusted process, where the trusted process is a non-malicious process known to the computer device; and if the target process is an untrusted process, performing data backup on the existing file to obtain backup data of the existing file.

### CROSS-REFERENCE TO RELATED APPLICATION

This application claims priority to Chinese Patent Application No. 202311715008.1, filed on Dec. 13, 2023, which is hereby incorporated by reference in its entirety.

### TECHNICAL FIELD

Embodiments relate to the field of computer technologies, and to a data backup method, apparatus, and system.

### BACKGROUND

With rapid development of information technologies, data plays an increasingly important role in the present era. The development and update of ransomware follow. Such viruses spread through computer vulnerabilities, emails, Trojan horses, web backdoors, and the like. Once a computer is infected with ransomware, the ransomware encrypts user data stored on the computer, so that a user (victim) of the computer infected with ransomware cannot access the data. In addition, the ransomware requires the victim to pay ransom to obtain a decryption key. Otherwise, the victim will lose data permanently. As massive data and ransomware emerge, the data security field also accordingly rises. The current key to improve data security is to perform secure backup on data to effectively recover original data after the user data is encrypted by the ransomware.

### SUMMARY

The embodiments a data backup method, apparatus, and system, to improve data security.

According to a first aspect, a data backup method is provided. A computer device obtains an input/output (input output, I/O) command for a file system of the computer device. If the I/O command instructs to perform a modification operation on an existing file in the file system, the computer device first performs a data backup procedure on the existing file, and then modifies the existing file according to the I/O command. The modification operation includes one or more of a delete operation, a rename operation, or a write operation. The data backup procedure includes: determining whether a target process initiating the I/O command is a trusted process, where the trusted process is a non-malicious process known to the computer device; and if the target process is an untrusted process, performing data backup on the existing file to obtain backup data of the existing file.

In the embodiments, data backup of the existing file is triggered based on a modification operation on the existing file in the file system, and data backup is performed on the existing file only when the modification operation is performed by an untrusted process. Comprehensiveness of data backup and an amount of backup data are comprehensively considered. Compared with an existing data backup solution that is coupled with ransomware detection, the solution of the embodiments implements more comprehensive data backup without relying on accuracy of determining the ransomware. Compared with an existing data backup solution that is decoupled from ransomware detection, in the solution of the embodiments, a data backup procedure is triggered based on a specific event, and whether a specific process performing an I/O operation is trusted is determined in combination with the specific event, so that an amount of backup data can be reduced, and storage resources can be saved.

Optionally, the computer device stores a trusted process list, and the trusted process list includes a process identifier of one or more trusted processes. An implementation in which the computer device determines whether the target process initiating the I/O command is a trusted process includes: If the trusted process list does not include a process identifier of the target process, the computer device determines that the target process is an untrusted process.

In the embodiments, the trusted process list is preconfigured in the computer device, so that the computer device can automatically determine, based on the trusted process list, whether a process is trusted, implementing automatic data backup.

Optionally, the computer device receives the trusted process list sent by a management device, where the trusted process list is generated based on processes that have been run by multiple computer devices. A trusted process indicated by a process identifier in the trusted process list meets that the trusted process has been run by the multiple computer devices for a quantity of times greater than a quantity-of-times threshold.

In the embodiments, the management device automatically generates and updates the trusted process list based on processes run on the multiple computer devices, and periodically delivers a latest trusted process list to the computer device, or delivers a changed trusted process list to the computer device after the trusted process list changes, implementing automatic configuration and update of the trusted process list on the computer device.

Optionally, the computer device stores an untrusted process list, and the untrusted process list includes a process identifier of one or more untrusted processes. An implementation in which the computer device determines whether the target process initiating the I/O command is a trusted process further includes: If the untrusted process list includes the process identifier of the target process, the computer device determines that the target process is an untrusted process. If the untrusted process list does not include the process identifier of the target process, the computer device determines whether the trusted process list includes the process identifier of the target process.

In the embodiments, the trusted process list and the untrusted process list are preconfigured in the computer device. Ransomware may exploit trusted software installed by a user to perform a ransomware operation. Therefore, a process identifier of a process that is of the trusted software and that may be exploited by the ransomware is added to the untrusted process list, and the computer device first determines, based on the untrusted process list, whether the target process is an untrusted process. When the target process cannot be determined as an untrusted process based on the untrusted process list, whether the target process is trusted is then determined based on the trusted process list. In this way, when the ransomware runs a process of the trusted software to perform a ransomware operation, the computer device can also implement data backup of a file, improving data security.

Optionally, the untrusted process list includes a process identifier of a process used for file compression and/or a process identifier of a process used to run a Java program.

Optionally, a process identifier of a process includes a process file path of the process and/or a process file content hash value of the process.

Optionally, the computer device stores a file path list, and the file path list includes one or more file paths. Correspondingly, if the target process is an untrusted process, and the file path list does not include a file path of the existing file, the computer device performs data backup on the existing file.

In the embodiments, a file path of an unimportant file that does not need to be protected against ransomware is preconfigured in the computer device, so that the computer device does not perform data backup on the unimportant file, reducing an amount of backup data.

Optionally, an implementation in which the computer device determines whether the target process initiating the I/O command is a trusted process includes: If the file path list does not include the file path of the existing file, the computer device determines whether the target process is a trusted process.

Optionally, the computer device stores a file type list, and the file type list includes one or more file types. Correspondingly, if the target process is an untrusted process, and the file type list includes a file type of the existing file, the computer device performs data backup on the existing file.

In the embodiments, an important file type that needs to be protected against ransomware is preconfigured in the computer device, so that the computer device performs data backup only on a file of an important file type, and does not perform data backup on a file of an unimportant file type, reducing an amount of backup data.

Optionally, an implementation in which the computer device determines whether the target process initiating the I/O command is a trusted process includes: If the file type list includes the file type of the existing file, the computer device determines whether the target process is a trusted process.

Optionally, after the computer device performs data backup on the existing file, in response to that the target process is ransomware, the computer device recovers the existing file based on the backup data of the existing file.

In the embodiments, data backup is decoupled from ransomware detection. After data backup of a file is completed, the computer device can automatically implement ransomware rollback in response to detection of the ransomware, implementing automatic data recovery.

Optionally, the computer device sends a file behavior log of the target process to the management device, where the file behavior log includes related information about an I/O operation performed by the target process on the file system within preset duration. The computer device receives a determining result that is of the target process and that is sent by the management device, where the determining result indicates whether the target process is ransomware.

In the embodiments, the management device performs ransomware determining on a process running on the computer device, reducing occupation of processing resources of the computer device.

Optionally, the computer device determines, based on the I/O operation performed by the target process on the file system within the preset duration, whether the target process is ransomware.

Optionally, a minifilter driver for the file system is installed in the computer device, and a callback function is compiled in the minifilter driver. An operating system of the computer device is configured to: when receiving the I/O command instructing to perform the modification operation on the existing file in the file system, call the callback function to perform the data backup procedure.

According to a second aspect, a data backup method is provided. A management device receives process logs sent by multiple computer devices, where the process log includes a process identifier of a process that has been run by the computer device. The management device generates a trusted process list based on the process logs sent by the multiple computer devices, where the trusted process list includes a process identifier of one or more trusted processes. A trusted process indicated by a process identifier in the trusted process list meets that the trusted process has been run by the multiple computer devices for a quantity of times greater than a quantity-of-times threshold. The management device sends the trusted process list to the multiple computer devices, where the trusted process list is used by the computer device to perform a data backup procedure on an existing file in a file system of the computer device.

In the embodiments, the management device automatically generates and updates the trusted process list based on processes run on the multiple computer devices, and periodically delivers a latest trusted process list to the computer device, or delivers a changed trusted process list to the computer device after the trusted process list changes, implementing automatic configuration and update of the trusted process list on the computer device.

Optionally, the management device receives a file behavior log of a target process sent by the computer device, where the file behavior log includes related information about an I/O operation performed by the target process on the file system of the computer device within preset duration. The management device determines, based on the related information about the I/O operation performed by the target process on the file system of the computer device within the preset duration, whether the target process is ransomware. The management device sends a determining result of the target process to the computer device, where the determining result indicates whether the target process is ransomware.

In the embodiments, the management device performs ransomware determining on a process running on the computer device, reducing occupation of processing resources of the computer device.

According to a third aspect, a data backup apparatus is provided. The data backup apparatus is used in a computer device. The data backup apparatus includes multiple functional modules, and the multiple functional modules interact with each other to implement the method according to the first aspect and the implementations of the first aspect. The multiple functional modules may be implemented based on software, hardware, or a combination of software and hardware, and the multiple functional modules may be randomly combined or divided based on specific implementation.

According to a fourth aspect, a data backup apparatus is provided. The data backup apparatus is used in a management device. The data backup apparatus includes multiple functional modules, and the multiple functional modules interact with each other to implement the method according to the second aspect and the implementations of the second aspect. The multiple functional modules may be implemented based on software, hardware, or a combination of software and hardware, and the multiple functional modules may be randomly combined or divided based on specific implementation.

According to a fifth aspect, a computer device is provided, including a memory, a network interface, and at least one processor. The memory is configured to store program instructions, and after the at least one processor reads the program instructions stored in the memory, the computer device is caused to perform the method according to the first aspect and the implementations of the first aspect.

According to a sixth aspect, a management device is provided, including a memory, a network interface, and at least one processor. The memory is configured to store program instructions, and after the at least one processor reads the program instructions stored in the memory, the management device is caused to perform the method according to the second aspect and the implementations of the second aspect.

According to a seventh aspect, a data backup system is provided. The system includes a computer device, and the computer device is configured to perform the method according to the first aspect and the implementations of the first aspect.

Optionally, the system includes a management device and multiple computer devices. The management device is configured to perform the method according to the second aspect and the implementations of the second aspect.

According to an eighth aspect, a non-transitory computer-readable storage medium is provided. The non-transitory computer-readable storage medium stores instructions, and when the instructions are executed by a processor, the method according to the first aspect and the implementations of the first aspect or the method according to the second aspect and the implementations of the second aspect is implemented.

According to a ninth aspect, a computer program product is provided, including a computer program. When the computer program is executed by a processor, the method according to the first aspect and the implementations of the first aspect is implemented, or the method according to the second aspect and the implementations of the second aspect is implemented.

According to a tenth aspect, a chip is provided. The chip includes a programmable logic circuit and/or program instructions. When the chip runs, the method according to the first aspect and the implementations of the first aspect or the method according to the second aspect and the implementations of the second aspect is implemented.

### BRIEF DESCRIPTION OF DRAWINGS

FIG. 1 is a diagram of a hardware structure of a computer device according to an embodiment;

FIG. 2 is a diagram of an implementation scenario according to an embodiment;

FIG. 3 is a schematic flowchart of a data backup method according to an embodiment;

FIG. 4 is a diagram of an implementation process of performing a data backup procedure on an existing file in a file system according to an embodiment;

FIG. 5 is a diagram of implementing file backup by a computer device according to an embodiment;

FIG. 6 is a diagram of an implementation process of a data backup method according to an embodiment;

FIG. 7 is a diagram of a structure of a data backup apparatus according to an embodiment; and

FIG. 8 is a diagram of a structure of another data backup apparatus according to an embodiment.

### DETAILED DESCRIPTION OF EMBODIMENTS

To make the objectives, solutions, and advantages clearer, the following further describes the implementations of the embodiments in detail with reference to the accompanying drawings.

Ransomware is a new type of computer virus that locks the computer system or files of the infected for extortion. Ransomware spreads through computer vulnerabilities, emails, Trojan horses, web backdoors, and the like. Once a computer is infected with the ransomware, files in almost all formats on the disk may be encrypted. As a result, a large quantity of important files of enterprises, schools, or individual users cannot be used or even leaked, severely affecting daily work and life. If the computer is infected with the ransomware, important files cannot be read, key data is damaged, and the computer is locked and cannot be used properly. To guide the infected to pay a ransom, the ransomware may also generate ransomware prompt files on the desktop or in other obvious positions. The infected needs to pay a high ransom to obtain decryption keys to recover the computer system and files for normal use. However, in most cases, even if a high ransom is paid, data may not be recovered. Therefore, the ransomware has the characteristics of high data recovery costs and little data recovery possibility.

Secure backup is performed on data so that original data can be effectively recovered after the user data is encrypted by the ransomware. This is a key measure to improve data security. Currently, there are two types of data backup solutions to cope with ransomware. One is to couple data backup with ransomware detection, and the other is to decouple data backup from ransomware detection. There are multiple existing solutions in which data backup is coupled with ransomware detection. For example, in a first solution, after it is determined that a process is ransomware, a file to be modified by the process is backed up. In a second solution, file content written by a process is redirected to a memory. If it is determined that the process is ransomware, the file content written by the process is discarded. If it is determined that the process is not ransomware, the file content is written back to the original file. There are also multiple existing solutions in which data backup is decoupled from ransomware detection. For example, in a third solution, incremental backup or full backup is performed on a file system as scheduled. In a fourth solution, files to be modified by a process are backed up indiscriminately, and file versions at different moments are provided. A user can manually select a file version at a time line.

However, in an existing solution in which data backup is coupled with ransomware detection, reliability of data backup completely relies on accuracy of ransomware detection. For example, in the first solution, if a false negative of ransomware occurs, a file infected by the ransomware is not backed up. As a result, the infected file cannot be recovered. For another example, in the second solution, if a false positive of ransomware occurs, file content written by normal software is discarded, affecting writing of a normal file; or if a false negative of ransomware occurs, a file encrypted by the ransomware is written into a normal file. However, in an existing solution in which data backup is decoupled from ransomware detection, a large amount of backup data is generated in most cases, and consequently, a large quantity of storage resources of a computer device are occupied.

Based on this, the embodiments provide a solution to decouple data backup from ransomware detection and trigger data backup based on an event, implementing secure backup of an existing file that may be attacked by a ransomware in a file system, and improving data security. A specific solution is as follows: a computer device obtains an I/O command for a file system of the computer device. If the I/O command instructs to perform a modification operation on an existing file in the file system, the computer device first performs a data backup procedure on the existing file, and then modifies the existing file according to the I/O command. The modification operation includes one or more of a delete operation, a rename operation, or a write operation. The data backup procedure includes: determining whether a target process initiating the I/O command is a trusted process, where the trusted process is a non-malicious process known to the computer device or a normal process that is known. If the target process is an untrusted process, data backup is performed on the existing file to obtain backup data of the existing file. An I/O operation of ransomware may involve modification of the existing file in the file system, including deleting the existing file, renaming the existing file, or writing new content into the existing file. In the embodiments, data backup of the existing file is triggered based on a modification operation on the existing file in the file system, and data backup is performed on the existing file only when the modification operation is performed by an untrusted process. Comprehensiveness of data backup and an amount of backup data are comprehensively considered. Compared with an existing data backup solution that is coupled with ransomware detection, the solution of the embodiments implements more comprehensive data backup without relying on accuracy of determining the ransomware. Compared with an existing data backup solution that is decoupled from ransomware detection, in the solution of the embodiments, a data backup procedure is triggered based on a specific event, and whether a specific process performing an I/O operation is trusted is determined in combination with the specific event, so that an amount of backup data can be reduced, and storage resources can be saved.

In some embodiments, the computer device stores a trusted process list, and the trusted process list includes a process identifier of one or more trusted processes. The trusted process list is equivalent to a process whitelist. In this implementation, the computer device determines whether the target process is a trusted process by determining whether the trusted process list includes a process identifier of the target process. If the trusted process list does not include the process identifier of the target process, the computer device determines that the target process is an untrusted process. In the embodiments, the computer device determines, based on a whitelist mechanism, whether a process is trusted. A trusted process list is preconfigured in a computer device, so that the computer device can automatically determine, based on the trusted process list, whether a process is trusted, implementing automatic data backup.

Optionally, a process identifier of a process includes a process file path of the process and/or a process file content hash value of the process. That is, a process identifier of a process is represented by using a process file path of the process, or is represented by using a process file content hash value of the process, or is represented by using a process file path of the process and a process file content hash value of the process.

For example, the process identifier is represented by using a process file path. For example, the trusted process list includes “% windows%\\explorer.exe”, indicating that a process running by the resource manager in the Windows system is a trusted process.

In some embodiments, in addition to the trusted process list, the computer device further stores an untrusted process list, and the untrusted process list includes a process identifier of one or more untrusted processes. The untrusted process list is equivalent to a process blacklist. In this implementation, the computer device first determines whether the untrusted process list includes the process identifier of the target process. If the untrusted process list includes the process identifier of the target process, the computer device determines that the target process is an untrusted process. If the untrusted process list does not include the process identifier of the target process, the computer device further determines whether the trusted process list includes the process identifier of the target process. In the embodiments, the computer device determines, based on a blacklist and whitelist mechanism, whether a process is trusted. A trusted process list and an untrusted process list are preconfigured in a computer device, and the computer device first determines, based on the untrusted process list, whether a target process is an untrusted process. When the target process cannot be determined as an untrusted process based on the untrusted process list, whether the target process is trusted is then determined based on the trusted process list. Ransomware may exploit trusted software installed by a user to perform a ransomware operation. Therefore, a process identifier of a process that is of the trusted software and that may be exploited by the ransomware is added to the untrusted process list, so that when the ransomware runs a process of the trusted software to perform a ransomware operation, the computer device can also implement data backup of a file, improving data security.

Optionally, the untrusted process list includes a process identifier of a process used for file compression and/or a process identifier of a process used to run a Java program. For example, the process identifier is represented by using a process file path, and the untrusted process list includes, for example, “\\rar.exe”, “\\7z.exe”, and “\\java.exe”. “\\rar.exe” and “\\7z.exe” are process identifiers of processes used for file compression, and “\\java.exe” is a process identifier of a process used for running a Java program. For example, some ransomware invokes the command line program rar.exe of the WinRar software to compress an existing file in the file system into a password-protected compressed file and then delete the existing file. Therefore, even if the WinRar installation directory is in the trusted process list, rar.exe in the directory cannot be trusted.

In some embodiments, the computer device stores a file path list, and the file path list includes one or more file paths. A file path in the file path set is a file path of an unimportant file that is determined in advance and that does not need to be protected against ransomware. Correspondingly, in the foregoing data backup procedure, if the target process is an untrusted process, and the file path list does not include a file path of the existing file, the computer device performs data backup on the existing file. On the contrary, if the target process is a trusted process, or the file path list includes the file path of the existing file, the computer device does not perform data backup on the existing file. In the embodiments, a file path of an unimportant file that does not need to be protected against ransomware is preconfigured in the computer device, so that the computer device does not perform data backup on the unimportant file, reducing an amount of backup data.

For example, the file path list includes a file path “\\AliWorkbenchData\\”.

Optionally, in the process of performing the foregoing data backup procedure, the computer device first determines whether the file path list includes the file path of the existing file. If the file path list does not include the file path of the existing file, the computer device determines whether the target process is a trusted process. If the file path list includes the file path of the existing file, the computer device stops performing the data backup procedure. That is, the computer device first determines whether an object to be modified by the I/O command for the file system is a file that needs to be protected against ransomware. After determining that the object to be modified is a file that needs to be protected against ransomware, the computer device determines whether the target process initiating the I/O command is a trusted process. Otherwise, the computer device does not enter a procedure of determining whether the target process is a trusted process. Also, the embodiments do not exclude a solution in which the computer device first determines whether the target process is a trusted process, and then determines, when determining that the target process is an untrusted process, whether the file path list includes the file path of the existing file to be modified by the target process.

In some embodiments, the computer device stores a file type list, and the file type list includes one or more file types. A file type in the file type list is a file type that is determined in advance and that needs to be protected against ransomware. Correspondingly, in the foregoing data backup procedure, if the target process is an untrusted process, and the file type list includes a file type of the existing file, the computer device performs data backup on the existing file. On the contrary, if the target process is a trusted process, or the file type list does not include the file type of the existing file, the computer device does not perform data backup on the existing file. In the embodiments, an important file type that needs to be protected against ransomware is preconfigured in the computer device, so that the computer device performs data backup only on a file of an important file type, and does not perform data backup on a file of an unimportant file type, reducing an amount of backup data.

Optionally, the file type is represented by using a file name extension (filename extension). The filename extension is also referred to as an extended filename, commonly known as a filename suffix, which is a mechanism used by an operating system to identify a file format. For example, the file type list includes one or more of rar, zip, 7z, csv, cpp, php, jsp, asp, h, cs, java, mdb, sql, der, json, xml, doc, html, htm, docx, xls, xlsx, xps, ppt, pptx, dwg, efi, eps, gif, hwp, jbw, jpeg, jpg, jps, jtd, key, lic, lnk, mp3, nc, odp, ods, odt, one, ost, pdf, pef, pem, ai, bmp, cer, crt, pfx, png, pst, ptx, rdp, rtf, tif, tiff, txt, x3f, and psd.

Optionally, in the process of performing the foregoing data backup procedure, the computer device first determines whether the file type list includes the file type of the existing file. If the file type list includes the file type of the existing file, the computer device determines whether the target process is a trusted process. If the file type list does not include the file type of the existing file, the computer device stops performing the data backup procedure. That is, the computer device first determines whether an object to be modified by the I/O command for the file system is of a file type that needs to be protected against ransomware. After determining that the object to be modified is of a file type that needs to be protected against ransomware, the computer device determines whether the target process initiating the I/O command is a trusted process. Otherwise, the computer device does not enter a procedure of determining whether the target process is a trusted process. Also, the embodiments do not exclude a solution in which the computer device first determines whether the target process is a trusted process, and then determines, when determining that the target process is an untrusted process, whether the file type list includes the file type of the existing file to be modified by the target process.

In some embodiments, after the computer device performs data backup on the existing file, in response to that the target process is ransomware, the computer device recovers the existing file based on the backup data of the existing file. In the embodiments, data backup is decoupled from ransomware detection. After data backup of a file is completed, the computer device can automatically implement ransomware rollback in response to detection of the ransomware, implementing automatic data recovery.

The following describes the solutions of the embodiments in detail from multiple perspectives such as hardware apparatus, implementation scenario, method procedure, and software apparatus.

The following describes a hardware apparatus in embodiments by using an example.

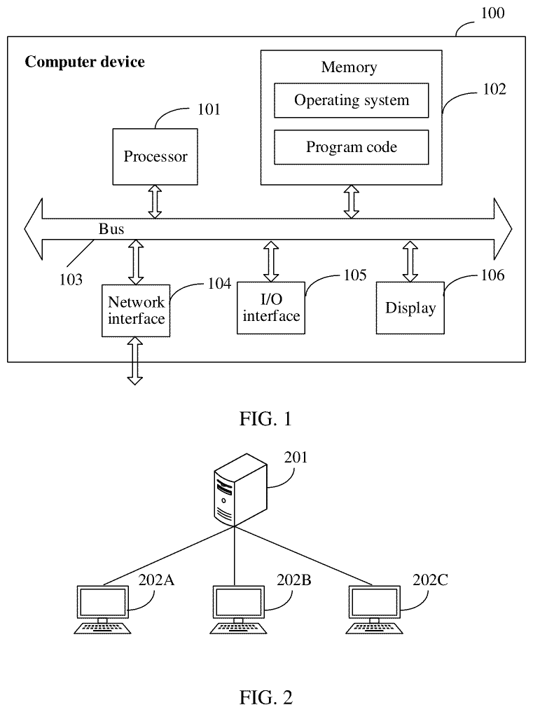

For example, FIG. 1 is a diagram of a hardware structure of a computer device 100 according to an embodiment. As shown in FIG. 1, the computer device 100 includes a processor 101 and a memory 102, and the processor 101 and the memory 102 are connected by using a bus 103. FIG. 1 is described by using an example in which the processor 101 and the memory 102 are independent of each other. Optionally, the processor 101 and the memory 102 are integrated together.

The memory 102 is configured to store a computer program, and the computer program includes an operating system and program code. The memory 102 is a storage medium of various types, for example, a read-only memory (ROM), a random access memory (RAM), an electrically erasable programmable read-only memory (EEPROM), a compact disc read-only memory (CD-ROM), a flash memory, an optical memory, a register, a compact disk storage, an optical disc storage, a magnetic disk, or another magnetic storage device.

The processor 101 is a general-purpose processor, a dedicated processor, or the like. The processor 101 may be a single-core processor or a multi-core processor. The processor 101 includes at least one circuit, to perform the data backup method provided in embodiments.

Optionally, the computer device 100 further includes a network interface 104, and the network interface 104 is connected to the processor 101 and the memory 102 through the bus 103. The network interface 104 can implement communication between the computer device 100 and another device.

Optionally, the computer device 100 further includes an I/O interface 105, and the I/O interface 105 is connected to the processor 101 and the memory 102 through the bus 103. The processor 101 can receive an input command, data, or the like over the I/O interface 105. The I/O interface 105 is configured to connect the computer device 100 to an input device, where the input device is, for example, a keyboard or a mouse. Optionally, in some possible scenarios, the network interface 104 and the I/O interface 105 are collectively referred to as communication interfaces.

Optionally, the computer device 100 further includes a display 106, and the display 106 is connected to the processor 101 and the memory 102 through the bus 103. The display 106 can be configured to display an intermediate result and/or a final result, such as backup data of a file or modified data of a file, generated when the processor 101 performs the data backup method provided in embodiments. In a possible implementation, the display 106 is a touchscreen, to provide a man-machine interaction interface.

The bus 103 is a communication bus of any type configured to implement interconnection between internal components of the computer device 100, for example, a system bus. In this embodiment, an example in which the foregoing internal components of the computer device 100 are interconnected through the bus 103 is used for description. Optionally, communication connections between the foregoing internal components of the computer device 100 are implemented in another connection mode other than the bus 103. For example, the foregoing internal components of the computer device 100 are interconnected through a logical interface inside the computer device 100.

The foregoing components may be separately disposed on chips that are independent of each other, or at least some or all of the components may be disposed on a same chip. Whether the components are separately disposed on different chips or integrated and disposed on one or more chips can depend on a requirement of a product design. This embodiment imposes no limitation on specific implementations of the foregoing components.

The computer device 100 shown in FIG. 1 is merely an example. In an implementation process, the computer device 100 may further include other components, which are not enumerated herein. The computer device 100 shown in FIG. 1 may perform data backup on an existing file in a file system by performing all or some steps of the data backup method provided in embodiments.

The following describes implementation scenarios of embodiments by using examples.

The data backup method provided in embodiments can be applied to various computer devices that may be attacked by ransomware. The computer device is, for example, a terminal device on which a file system is deployed, and includes, but is not limited to, a server, a host, a personal computer, a mobile phone, or a workstation.

The computer device performs an I/O operation on the file system by running a process. A process file in the computer device can be stored on a hard disk drive, and the process file includes an executable program. The executable program in the process file is loaded to a memory to run, that is, the process is run. A process is a representation of the executable program in the file after the program is run.

Optionally, the computer device stores one or more of a trusted process list, an untrusted process list, a file path list, or a file type list. These lists are manually configured by a user in the computer device, or are delivered by a management device to the computer device. The trusted process list may be automatically generated and updated by the management device. The untrusted process list, the file path list, and the file type list may be configured according to expert experience.

For example, FIG. 2 is a diagram of an implementation scenario according to an embodiment. As shown in FIG. 2, the implementation scenario includes a management device 201 and multiple computer devices 202A to 202C (collectively referred to as computer devices 202). A quantity of computer devices in FIG. 2 is merely used as an example for description, and is not intended to limit an implementation scenario in embodiments.

Optionally, the management device 201 is a server, or a server cluster including multiple servers, or a cloud computing platform. For example, for a hardware structure of the management device 201, refer to the computer device 100 shown in FIG. 1. The computer device 202 is, for example, the computer device 100 shown in FIG. 1. Optionally, the management device 201 is connected to the computer device 202 through a wireless network or a wired network.

Optionally, the management device 201 can be configured to train and deliver one or more lists used by the computer device 202 to perform a data backup procedure. For example, each computer device 202 collects a process log, and sends the collected process log to the management device 201, where the process log includes a process identifier of a process that has been run by the computer device 202. The management device 201 determines, based on process logs separately sent by the multiple computer devices 202, processes that have been run by the multiple computer devices 202, then clusters all the processes that have been run by the multiple computer devices 202, determines a process that has been run for a quantity of times greater than a quantity-of-times threshold as a trusted process, and generates a trusted process list and delivers the trusted process list to the computer devices 202. In addition, the management device 201 can further periodically update the trusted process list based on the process logs reported by the multiple computer devices 202, and deliver an updated trusted process list to the multiple computer devices 202, to implement automatic generation and update of the trusted process list.

Optionally, the management device 201 can be further configured to determine whether a process running on the computer device 202 is ransomware. For example, the computer device 202 sends a file behavior log of a process that has been run to the management device. The file behavior log includes related information about an I/O operation performed by the process on a file system within preset duration, for example, an I/O command, a parameter of the I/O command, an execution result of the I/O command, or an occurrence time of the I/O command. The management device 201 determines, based on the related information about the I/O operation performed by the process on the file system within the preset duration, whether the process is ransomware, and delivers a determining result of the process to the computer device 202, to indicate whether the process is ransomware. If the management device 201 determines that a process running on the computer device 202 is ransomware, the management device 201 can further send a rollback command to the computer device 202, to instruct the computer device 202 to roll back to a state before the ransomware modifies the file in the file system.

The following describes method procedures in embodiments by using examples.

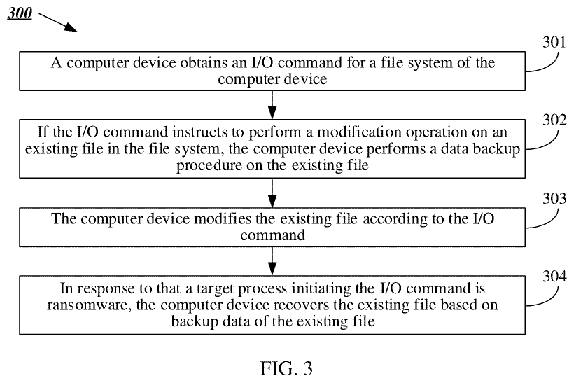

For example, FIG. 3 is a schematic flowchart of a data backup method 300 according to an embodiment. As shown in FIG. 3, the method 300 includes, but is not limited to, the following step 301 to step 303. Optionally, the method 300 further includes the following step 304. Optionally, a computer device in the method 300 is the computer device 100 shown in FIG. 1, or any computer device 202 shown in FIG. 2.

Step 301: A computer device obtains an I/O command for a file system of the computer device.

The I/O command is sent by the computer device in a process of running a target process, that is, the I/O command is initiated by the target process.

Optionally, the I/O command includes a read command, a write command, a delete command, a create command, and a rename command. The read command instructs to read data from an existing file in the file system, that is, to perform a read operation. The write command instructs to write data into an existing file in the file system, that is, to perform a write operation. The delete command instructs to delete an existing file in the file system, that is, to perform a delete operation. The create command instructs to create a file in the file system, that is, to perform a create operation. The rename command instructs to rename an existing file in the file system, that is, to perform a rename operation. In this embodiment, performing a write operation, a delete operation, and a rename operation on an existing file in the file system is considered as performing a modification operation on the existing file.

Step 302: If the I/O command instructs to perform a modification operation on an existing file in the file system, the computer device performs a data backup procedure on the existing file.

The data backup procedure includes: the computer device determines whether the target process initiating the I/O command is a trusted process, where the trusted process is a non-malicious process known to the computer device; and if the target process is an untrusted process, the computer device performs data backup on the existing file to obtain backup data of the existing file.

Optionally, the computer device stores the backup data of the existing file in a protected area of a local hard disk drive, and data stored in the protected area cannot be modified by a process. Alternatively, the computer device stores the backup data of the existing file in an external storage device, where the external storage device includes, but is not limited to, a network storage device or a dedicated storage device externally connected to the computer device.

An I/O operation of ransomware can involve modification of the existing file in the file system, including deleting the existing file, renaming the existing file, or writing new content into the existing file. In embodiments, data backup of the existing file is triggered based on a modification operation on the existing file in the file system, and data backup is performed on the existing file only when the modification operation is performed by an untrusted process. Comprehensiveness of data backup and an amount of backup data are comprehensively considered. Compared with an existing data backup solution that is coupled with ransomware detection, the solution of the embodiments implements more comprehensive data backup without relying on accuracy of determining the ransomware. Compared with an existing data backup solution that is decoupled from ransomware detection, in the solution of the embodiments, a data backup procedure is triggered based on a specific event, and whether a specific process performing an I/O operation is trusted is determined in combination with the specific event, so that an amount of backup data can be reduced, and storage resources can be saved.

Optionally, the computer device stores one or more of a trusted process list, an untrusted process list, a file path list, or a file type list. The trusted process list is equivalent to a process whitelist, and includes a process identifier of one or more trusted processes. The untrusted process list is equivalent to a process blacklist, and includes a process identifier of one or more untrusted processes. The file path list includes one or more file paths, and a file path in the file path list is a file path of an unimportant file that does not need to be protected against ransomware. The file type list includes one or more file types, and a file type in the file type list is an important file type that needs to be protected against ransomware. Optionally, a process identifier of a process includes a process file path of the process and/or a process file content hash value of the process.

In a first case, the computer device stores a trusted process list. An implementation in which the computer device determines whether the target process initiating the I/O command is a trusted process includes: If the trusted process list does not include a process identifier of the target process, the computer device determines that the target process is an untrusted process. On the contrary, if the trusted process list includes the process identifier of the target process, the computer device determines that the target process is a trusted process.

In this embodiment, the trusted process list is preconfigured in the computer device, so that the computer device can automatically determine, based on the trusted process list, whether a process is trusted, implementing automatic data backup.

Optionally, the computer device receives the trusted process list sent by a management device, where the trusted process list is generated based on processes that have been run by multiple computer devices. A trusted process indicated by a process identifier in the trusted process list meets that the trusted process has been run by the multiple computer devices for a quantity of times greater than a quantity-of-times threshold.

In this embodiment, the multiple computer devices separately send process logs to the management device, where the process log includes a process identifier of a process that has been run by the computer device, so that the management device generates the trusted process list based on the process logs sent by the multiple computer devices and delivers the trusted process list to the computer device. In specific implementation, the management device may also automatically update the trusted process list based on a process running on the computer device, and periodically deliver a latest trusted process list to the computer device, or deliver a changed trusted process list to the computer device after the trusted process list changes, implementing automatic configuration and update of the trusted process list on the computer device.

In a second case, the computer device stores a trusted process list and an untrusted process list. An implementation in which the computer device determines whether the target process initiating the I/O command is a trusted process includes: If the untrusted process list includes a process identifier of the target process, the computer device determines that the target process is an untrusted process. If the untrusted process list does not include the process identifier of the target process, the computer device determines whether the trusted process list includes the process identifier of the target process.

In this embodiment, the trusted process list and the untrusted process list are preconfigured in the computer device. Ransomware may exploit trusted software installed by a user to perform a ransomware operation. Therefore, a process identifier of a process that is of the trusted software and that may be exploited by the ransomware is added to the untrusted process list, and the computer device first determines, based on the untrusted process list, whether the target process is an untrusted process. When the target process cannot be determined as an untrusted process based on the untrusted process list, whether the target process is trusted is then determined based on the trusted process list. In this way, when the ransomware runs a process of the trusted software to perform a ransomware operation, the computer device can also implement data backup of a file, improving data security.

In a third case, the computer device stores a file path list. In the foregoing data backup procedure, if the target process is an untrusted process, and the file path list does not include a file path of the existing file, the computer device performs data backup on the existing file. On the contrary, if the target process is a trusted process, or the file path list includes the file path of the existing file, the computer device does not perform data backup on the existing file.

In this embodiment, a file path of an unimportant file that does not need to be protected against ransomware is preconfigured in the computer device, so that the computer device does not perform data backup on the unimportant file, reducing an amount of backup data.

Optionally, in the foregoing third case, the data backup procedure performed by the computer device on the existing file includes: if the file path list does not include the file path of the existing file, the computer device determines whether the target process is a trusted process. On the contrary, if the file path list includes the file path of the existing file, the computer device stops performing the data backup procedure, in other words, the computer device does not perform data backup on the existing file.

In a fourth case, the computer device stores a file type list. In the foregoing data backup procedure, if the target process is an untrusted process, and the file type list includes a file type of the existing file, the computer device performs data backup on the existing file. On the contrary, if the target process is a trusted process, or the file type list does not include the file type of the existing file, the computer device does not perform data backup on the existing file.

In this embodiment, an important file type that needs to be protected against ransomware is preconfigured in the computer device, so that the computer device performs data backup only on a file of an important file type, and does not perform data backup on a file of an unimportant file type, reducing an amount of backup data.

Optionally, in the foregoing fourth case, the data backup procedure performed by the computer device on the existing file includes: if the file type list includes the file type of the existing file, the computer device determines whether the target process is a trusted process. On the contrary, if the file type list does not include the file type of the existing file, the computer device stops performing the data backup procedure, in other words, the computer device does not perform data backup on the existing file.

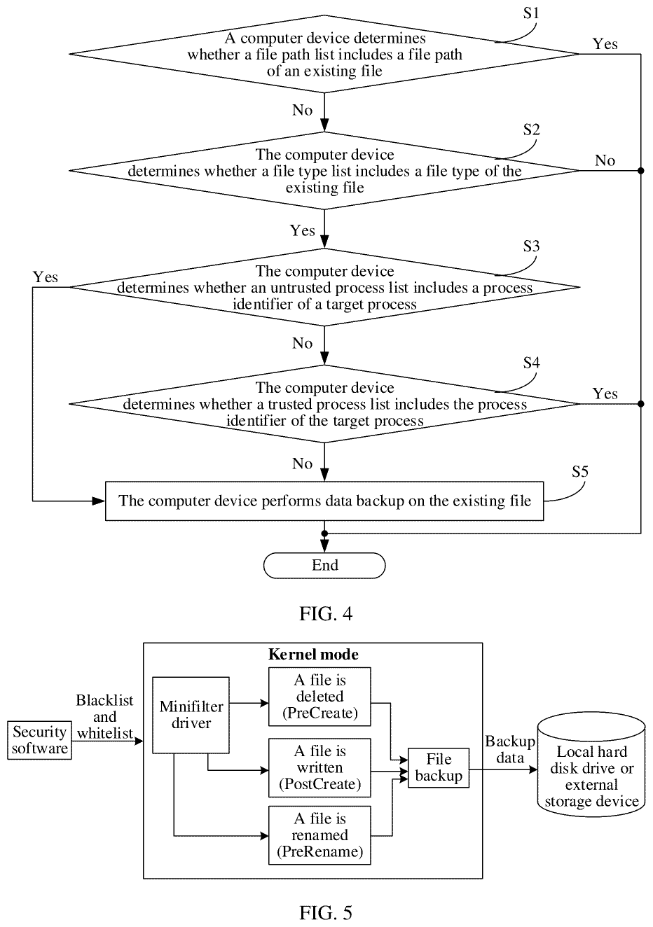

Optionally, if the computer device stores multiple types of lists, when the computer device performs a data backup procedure on a file, a sequence of using the multiple types of lists is not limited. For example, the computer device first performs important file screening based on the file path list, then performs important file type screening based on the file type list, and determines, based on the untrusted process list and the trusted process list, whether a process performing a modification operation on the file is trusted. For another example, the computer device first performs important file type screening based on the file type list, then performs important file screening based on the file path list, and determines, based on the untrusted process list and the trusted process list, whether a process performing a modification operation on the file is trusted. For another example, the computer device first determines, based on the untrusted process list and the trusted process list, whether a process performing a modification operation on the file is trusted, then performs important file screening based on the file path list, and performs important file type screening based on the file type list. In the following embodiments, an example in which the computer device stores the trusted process list, the untrusted process list, the file path list, and the file type list is used to describe an implementation process of the foregoing data backup procedure performed by the computer device. For example, FIG. 4 is a diagram of an implementation process of performing a data backup procedure on an existing file in a file system according to an embodiment. As shown in FIG. 4, the implementation process includes, but is not limited to, the following step Se to step S5.

Step S1: A computer device determines whether a file path list includes a file path of an existing file. If the file path list does not include the file path of the existing file, step S2 is performed. If the file path list includes the file path of the existing file, the data backup procedure is ended.

If the file path list includes the file path of the existing file, it indicates that the existing file is an unimportant file. In this case, data backup does not need to be performed on the existing file.

Step S2: The computer device determines whether a file type list includes a file type of the existing file. If the file type list includes the file type of the existing file, step S3 is performed. If the file type list does not include the file type of the existing file, the data backup procedure is ended.

If the file type list does not include the file type of the existing file, it indicates that the file type of the existing file is an unimportant file type. In this case, data backup does not need to be performed on the existing file.

Step S3: The computer device determines whether an untrusted process list includes a process identifier of a target process. If the untrusted process list does not include the process identifier of the target process, step S4 is performed. If the untrusted process list includes the process identifier of the target process, step S5 is performed.

If the untrusted process list includes the process identifier of the target process, it indicates that the target process is an untrusted process. In this case, data backup needs to be performed on an object to be modified the target process.

Step S4: The computer device determines whether a trusted process list includes the process identifier of the target process. If the trusted process list does not include the process identifier of the target process, step S5 is performed. If the trusted process list includes the process identifier of the target process, the data backup procedure is ended.

If the trusted process list includes the process identifier of the target process, it indicates that the target process is a non-malicious process known to the computer device. In this case, data backup does not need to be performed on the object to be modified by the target process.

Step S5: The computer device performs data backup on the existing file.

Optionally, a minifilter driver for a file system is installed in the computer device. A callback function is compiled in the minifilter driver. An operating system of the computer device is configured to: when receiving the I/O command instructing to perform the modification operation on the existing file in the file system, call the callback function to perform the data backup procedure.

The data backup method provided in this embodiment may be implemented by installing security software on the computer device. When the security software is installed on the computer device, the security software installs a minifilter driver for the file system. A callback function is compiled in the minifilter driver. After being executed, the minifilter driver registers the callback function with the Windows file system filter manager. When detecting an I/O command instructing to perform a modification operation on the existing file in the file system, the Windows file system filter manager calls the registered callback function, to obtain a process identifier of a process initiating the I/O command, a file path or a file type of the file to be modified, and further implement file backup.

For example, FIG. 5 is a diagram of implementing file backup by a computer device according to an embodiment. As shown in FIG. 5, security software transfers a blacklist and whitelist to a minifilter driver, where the blacklist and whitelist include one or more of a trusted process list, an untrusted process list, a file path list, or a file type list. The minifilter driver saves the blacklist and whitelist to internal variables. After a callback function in the minifilter driver is called by an operating system of a computer device, the foregoing data backup procedure is implemented based on the blacklist and whitelist, to complete file backup, and, backup data is stored in a local hard disk drive or an external storage device. The security software is run by the computer device in a user mode, and the minifilter driver is run by the computer device in a kernel mode. For example, the callback functions include PreCreate, PostCreate, and PreRename. PreCreate is called when a file is about to be deleted, PostCreate is called when a file is about to be written, and PreRename is called when a file is about to be renamed.

Further, after completing the data backup procedure on the existing file, the computer device continues to perform the following step 303.

Step 303: The computer device modifies the existing file according to the I/O command.

Optionally, the computer device performs one or more of a delete operation, a rename operation, or a write operation on the existing file according to the I/O command. For example, the computer device first performs a rename operation on the existing file according to the I/O command, and then performs a write operation on the existing file; or the computer device first performs a write operation on the existing file according to the I/O command, and then performs a rename operation on the existing file.

Optionally, after modifying the existing file in the file system according to the I/O command initiated by the target process, the computer device continues to perform the following step 304.

Step 304: In response to that the target process initiating the I/O command is ransomware, the computer device recovers the existing file based on the backup data of the existing file.

Optionally, the computer device determines whether the target process is ransomware. For example, the computer device determines, based on an I/O operation performed by the target process on the file system within preset duration, whether the target process is ransomware. Alternatively, the management device determines whether the target process is the ransomware, and the computer device determines, based on a determining result of the management device, whether the target process is ransomware. For example, the computer device sends a file behavior log of the target process to the management device, where the file behavior log includes related information about an I/O operation performed by the target process on the file system within preset duration. The management device determines, based on the related information about the I/O operation performed by the target process on the file system within the preset duration, whether the target process is ransomware. The management device sends a determining result of the target process to the computer device, where the determining result indicates whether the target process is ransomware. The computer device determines, based on the received determining result, whether the target process is ransomware. For example, the determining result includes the process identifier of the target process and a ransomware indication. The process identifier indicates that an object to be determined is the target process, and the ransomware indication indicates whether the object to be determined is ransomware.

Optionally, there are multiple implementations in which the computer device or the management device determines, based on the I/O operation performed by the target process on the file system within the preset duration, whether the target process is ransomware. For example, when a quantity of modification operations performed by the target process on the file system within the preset duration reaches a preset threshold, it is determined that the target process is ransomware. Alternatively, when continuous I/O operations performed by the target process on the file system within the preset duration meet a preset ransomware operation sequence, it is determined that the target process is ransomware. The ransomware operation sequence is set based on an attack behavior of the ransomware, for example, includes a read-overwrite operation, a write-delete operation, or a read-delete-write operation on a same file. A manner of determining whether a process is ransomware is not limited in this embodiment. Alternatively, the management device comprehensively determines, based on information in the file behavior log and with reference to a traffic behavior characteristic of the computer device that sends the file behavior log, whether the target process is ransomware. The traffic behavior characteristic may be reported by a security device in a network in which the computer device is located, and the security device includes a firewall, a security gateway, a probe, and the like.

Optionally, after determining that the target process is ransomware, the computer device directly recovers the existing file based on the backup data of the existing file, that is, directly performs state rollback, to restore the file system to a state before the target process modifies the existing file in the file system. Alternatively, the computer device recovers the existing file based on the backup data of the existing file with confirmation of a user. For example, in a case in which the computer device determines that the target process is ransomware, the computer device first displays backup data of a file modified by the target process in the file system and latest data after modification, and the user confirms on the computer device whether to perform data recovery. For another example, in a case in which the management device determines that the target process is ransomware, the computer device sends, to the management device, backup data of a file modified by the target process in the file system and latest data after modification, and the management device displays the backup data and the latest data. The user confirms, on the management device, whether to perform data recovery. After the user confirms to perform data recovery, the management device sends a rollback command to the computer device, to instruct the computer device to perform data recovery. Alternatively, the computer device performs state rollback according to a policy. In some states, state rollback is directly performed. In some states, it is determined with reference to a user whether to perform state rollback. In some states, state rollback is delayed. For example, when an operating load of a processor of the computer device is higher than a specific proportion, after determining that the target process is ransomware, the user determines whether to perform state rollback. When the operating load of the processor is lower than the specific proportion, state rollback is directly performed after it is determined that the target process is ransomware. For another example, a rollback time period is preconfigured in the computer device, and the computer device performs, in the rollback time period, state rollback on files modified by the ransomware. A policy for the computer device to recover the file modified by the ransomware in the file system is not limited in this embodiment.

In this embodiment, data backup is decoupled from ransomware detection. After data backup of a file is completed, the computer device can automatically implement ransomware rollback in response to detection of the ransomware, implementing automatic data recovery.

Optionally, after determining that the target process is ransomware, the computer device deletes a file created by the target process, for example, a ransomware prompt file and an encrypted file created in the file system, to implement thorough and automatic cleaning of the ransomware.

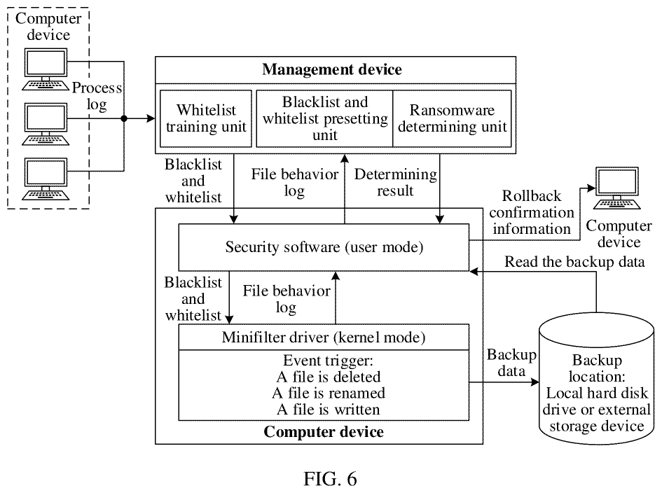

In this embodiment, the implementation scenario shown in FIG. 2 is used as an example to describe an implementation solution of the foregoing data backup method. For example, FIG. 6 is a diagram of an implementation process of a data backup method according to an embodiment. As shown in FIG. 6, a management device includes a whitelist training unit, a blacklist and whitelist presetting unit, and a ransomware determining unit. The whitelist training unit is configured to obtain a trusted process through training and extraction based on process logs collected by multiple computer devices. The blacklist and whitelist presetting unit is configured to store a known blacklist and whitelist, including a trusted process list, an untrusted process list, a file path list, a file type list, or the like. The blacklist and whitelist in the blacklist and whitelist presetting unit are delivered to the computer device. The ransomware determining unit is configured to determine, based on a file behavior log of a process reported by the computer device, whether the process is ransomware, and deliver a determining result to the computer device. The computer device runs security software in a user mode, and runs a minifilter driver in a kernel mode. The computer device transfers, to the minifilter driver running in the kernel mode, the blacklist and whitelist received by the security software running in the user mode. The minifilter driver is configured to perform a data backup procedure by using the blacklist and whitelist when a file is deleted, renamed, or written, and store backup data to a local hard disk drive or an external storage device. The computer device further obtains a file behavior log of a process by running the security software, and reports the file behavior log to the management device. Then, after receiving the determining result sent by the management device indicating that the process is ransomware, the computer device reads backup data from a backup location by running the security software, and performs, based on the backup data, data recovery on a file modified by the ransomware. Alternatively, the computer device may first output rollback confirmation information, where the rollback confirmation information includes backup data of a file modified by the ransomware and latest data after modification, and a user determines whether to perform file state rollback.

A sequence of steps of the foregoing data backup method provided in this embodiment can be properly adjusted, and steps can also be correspondingly added or deleted based on a situation. Any method variation readily figured out by any person skilled in the art shall fall within the scope of the embodiments. For example, in this embodiment, the file path list configured in the computer device includes a file path of an unimportant file that does not need to be protected against ransomware. Similarly, a file path of an important file that needs to be protected against ransomware may also be configured in the computer device. In this way, it may be determined whether an object to be modified by a process is an important file. When it is determined that the object to be modified by the process is an important file, whether data backup needs to be performed on the important file is further determined. For another example, in this embodiment, the file type list configured in the computer device includes an important file type that needs to be protected against ransomware. Similarly, an unimportant file type that does not need to be protected against ransomware may also be configured in the computer device. In this way, it may be determined whether a file type of an object to be modified by a process is an unimportant file type. When it is determined that the file type of the object to be modified by the process is not an unimportant file type, whether data backup needs to be performed on the file is further determined. Details are not described in this embodiment again.

The following describes a software apparatus in embodiments by using an example.

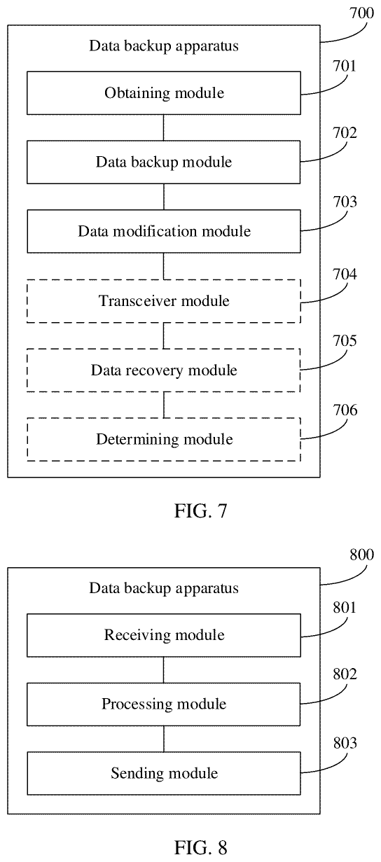

FIG. 7 is a diagram of a structure of a data backup apparatus according to an embodiment. A data backup apparatus having the structure shown in FIG. 7 is configured to implement the method 300 described in the foregoing embodiment. Optionally, the data backup apparatus shown in FIG. 7 is the computer device shown in FIG. 1 or FIG. 2. As shown in FIG. 7, the data backup apparatus 700 includes an obtaining module 701, a data backup module 702, and a data modification module 703. Optionally, still refer to FIG. 7. The data backup apparatus 700 further includes one or more of a transceiver module 704, a data recovery module 705, or a determining module 706.

The obtaining module 701 is configured to obtain an I/O command for a file system of the computer device. The data backup module 702 is configured to: if the I/O command instructs to perform a modification operation on an existing file in the file system, perform a data backup procedure on the existing file. The data modification module is configured to modify the existing file according to the I/O command. The modification operation includes one or more of a delete operation, a rename operation, or a write operation. The data backup procedure includes: determining whether a target process initiating the I/O command is a trusted process, where the trusted process is a non-malicious process known to the computer device; and if the target process is an untrusted process, performing data backup on the existing file to obtain backup data of the existing file.

Herein, for implementation processes of the obtaining module 701, the data backup module 702, and the data modification module 703, refer to the descriptions in the foregoing method embodiments. For example, the obtaining module 701 follows step 301 in the method 300 to obtain the I/O command for the file system of the computer device; the data backup module 702 follows step 302 in the method 300 to perform the data backup procedure on the existing file in the file system of the I/O command instructs to perform a modification operation on the existing file in the file system; and the data modification module 703 follows step 303 in the method 300 to modify the existing file according to the I/O command. Details are not described herein again in this embodiment.

Optionally, the computer device stores a trusted process list, and the trusted process list includes a process identifier of one or more trusted processes. The data backup module 702 is configured to: if the trusted process list does not include a process identifier of the target process, determine that the target process is an untrusted process.

Optionally, the transceiver module 704 is configured to receive the trusted process list sent by a management device, where the trusted process list is generated based on processes that have been run by multiple computer devices. A trusted process indicated by a process identifier in the trusted process list meets that the trusted process has been run by the multiple computer devices for a quantity of times greater than a quantity-of-times threshold.

Optionally, the computer device stores an untrusted process list, and the untrusted process list includes a process identifier of one or more untrusted processes. The data backup module 702 is configured to: if the untrusted process list includes the process identifier of the target process, determine that the target process is an untrusted process; or if the untrusted process list does not include the process identifier of the target process, determine whether the trusted process list includes the process identifier of the target process.

Optionally, the untrusted process list includes a process identifier of a process used for file compression and/or a process identifier of a process used to run a Java program.

Optionally, a process identifier of a process includes a process file path of the process and/or a process file content hash value of the process.

Optionally, the computer device stores a file path list, and the file path list includes one or more file paths. The data backup module 702 is configured to: if the target process is an untrusted process, and the file path list does not include a file path of the existing file, perform data backup on the existing file.

Optionally, the data backup module 702 is configured to: if the file path list does not include the file path of the existing file, determine whether the target process is a trusted process.

Optionally, the computer device stores a file type list, and the file type list includes one or more file types. The data backup module 702 is configured to: if the target process is an untrusted process, and the file type list includes a file type of the existing file, perform data backup on the existing file.

Optionally, the data backup module 702 is configured to: if the file type list includes the file type of the existing file, determine whether the target process is a trusted process.

Optionally, the data recovery module 705 is configured to: after performing data backup on the existing file and in response to that the target process is ransomware, recover the existing file based on the backup data of the existing file. Herein, for an implementation process of the data recovery module 705, refer to related descriptions of step 304 in the method 300.

Optionally, the transceiver module 704 is further configured to: send a file behavior log of the target process to the management device, where the file behavior log includes related information about an I/O operation performed by the target process on the file system within preset duration; and receive a determining result of the target process sent by the management device, where the determining result indicates whether the target process is ransomware.

Optionally, the determining module 706 is configured to determine, based on the related information about the I/O operation performed by the target process on the file system within the preset duration, whether the target process is ransomware.

Optionally, a minifilter driver for the file system is installed in the computer device, a callback function is compiled in the minifilter driver, and an operating system of the computer device is configured to: when receiving the I/O command instructing to perform the modification operation on the existing file in the file system, call the callback function to perform the data backup procedure.

The apparatus embodiment shown in FIG. 7 is merely an example. For example, the module division is merely logical function division and may be other division during actual implementation. For example, multiple modules or components may be combined or integrated into another system, or some features may be ignored or not performed. Functional modules in this embodiment may be integrated into one processing module, or each module may exist alone physically, or two or more modules may be integrated into one module. The foregoing modules in FIG. 7 may be implemented in a form of hardware, or may be implemented in a form of a software functional unit. For example, when software is used for implementation, the obtaining module 701, the data backup module 702, the data modification module 703, the data recovery module 705, and the determining module 706 may be implemented as software functional modules generated after the processor 101 in FIG. 1 reads the program instructions stored in the memory 102. The foregoing modules in FIG. 7 may alternatively be separately implemented as different hardware of the computer device. For example, the obtaining module 701, the data backup module 702, the data modification module 703, the data recovery module 705, and the determining module 706 are implemented as some processing resources in the processor 101 (for example, one core in a multi-core processor) in FIG. 1, and the transceiver module 704 is implemented as the network interface 104 and other processing resources in the processor 101 (for example, another core in the multi-core processor) in FIG. 1. It is clear that the foregoing functional modules may also be implemented by combining software and hardware. For example, the transceiver module 704 is implemented as a hardware programmable device, and the obtaining module 701, the data backup module 702, the data modification module 703, the data recovery module 705, and the determining module 706 are software functional modules generated after the processor reads the program instructions stored in the memory.

FIG. 8 is a diagram of a structure of another data backup apparatus according to an embodiment. A data backup apparatus having the structure shown in FIG. 8 is configured to implement the method described in the foregoing method embodiments. Optionally, the data backup apparatus shown in FIG. 8 is the management device shown in FIG. 2. As shown in FIG. 8, the data backup apparatus 800 includes, but is not limited to, a receiving module 801, a processing module 802, and a sending module 803.

The receiving module 801 is configured to receive process logs sent by multiple computer devices, where the process log includes a process identifier of a process that has been run by the computer device. The processing module 802 is configured to generate a trusted process list based on the process logs sent by the multiple computer devices, where the trusted process list includes a process identifier of one or more trusted processes, and a trusted process indicated by a process identifier in the trusted process list meets that the trusted process has been run by the multiple computer devices for a quantity of times greater than a quantity-of-times threshold. The sending module 803 is configured to send the trusted process list to the multiple computer devices, where the trusted process list is used by the computer device to perform a data backup procedure on an existing file in a file system of the computer device.

Optionally, the receiving module 801 is further configured to receive a file behavior log of a target process sent by the computer device, where the file behavior log includes related information about an I/O operation performed by the target process on the file system of the computer device within preset duration. The processing module 802 is further configured to determine, based on the related information about the I/O operation performed by the target process on the file system of the computer device within the preset duration, whether the target process is ransomware. The sending module 803 is further configured to send a determining result of the target process to the computer device, where the determining result indicates whether the target process is ransomware.

The apparatus embodiment shown in FIG. 8 is merely an example. For example, the module division is merely logical function division and may be other division during actual implementation. For example, multiple modules or components may be combined or integrated into another system, or some features may be ignored or not performed. Functional modules in this embodiment may be integrated into one processing module, or each module may exist alone physically, or two or more modules may be integrated into one module. The foregoing modules in FIG. 8 may be implemented in a form of hardware, or may be implemented in a form of a software functional unit.

An embodiment further provides a computer device, including a memory, a network interface, and at least one processor. The memory is configured to store program instructions. After the at least one processor reads the program instructions stored in the memory, the computer device is caused to perform the steps performed by the computer device in the foregoing method embodiments. Optionally, a hardware structure of the computer device is shown in FIG. 1.

An embodiment further provides a management device, including a memory, a network interface, and at least one processor. The memory is configured to store program instructions. After the at least one processor reads the program instructions stored in the memory, the computer device is caused to perform the steps performed by the management device in the foregoing method embodiments. Optionally, for a hardware structure of the management device, refer to the computer device 100 shown in FIG. 1.

An embodiment further provides a data backup system, including a computer device. The computer device is configured to perform the steps performed by the computer device in the foregoing method embodiments.

Optionally, the data backup system includes a management device and multiple computer devices. For a structure of the data backup system, refer to FIG. 2.

An embodiment further provides a non-transitory computer-readable storage medium. The non-transitory computer-readable storage medium stores instructions. When the instructions are executed by a processor of a computer device, the steps performed by the computer device in the foregoing method embodiments are implemented. Alternatively, when the instructions are executed by a processor of a management device, the steps performed by the management device in the foregoing method embodiments are implemented.

An embodiment further provides a computer program product, including a computer program. When the computer program is executed by a processor of a computer device, the steps performed by the computer device in the foregoing method embodiments are implemented. Alternatively, when the computer program is executed by a processor of a management device, the steps performed by the management device in the foregoing method embodiments are implemented.

Embodiments herein are described in a progressive manner. For same or similar parts in the embodiments, mutual reference may be made. Each embodiment focuses on a difference from other embodiments.

In the s embodiments, the terms “first”, “second”, and the like are for distinguishing between different objects, but are not intended to describe a particular order of the objects, and cannot be understood as an indication or implication of relative importance. For example, a first TCP packet and a second TCP packet are used to distinguish between packets sent at different moments, but are not used to describe a specific order of the packets.

In the descriptions of embodiments, unless otherwise stated, “at least one” means one or more. “Multiple” means two or more.

That A refers to B means that A is the same as B or that A is a simple variant of B.

In the embodiments, the term “and/or” is merely an association relationship that describes associated objects, and represents that there are three relationships. For example, A and/or B represents three cases: only A exists, both A and B exist, and only B exists. In addition, the character “/” generally indicates an “or” relationship between the associated objects.

Optionally, all or some of the foregoing embodiments are implemented by using software, hardware, firmware, or any combination thereof. Optionally, when software is used for implementation, embodiments are implemented completely or partially in a form of a computer program product. The computer program product includes one or more computer instructions. When the computer program instructions are loaded and executed on a computer, all or some of the described procedures or functions according to embodiments are generated. Optionally, the computer is a general-purpose computer, a dedicated computer, a computer network, or another programmable apparatus. Optionally, the computer instructions are stored in a non-transitory computer-readable storage medium or are transmitted from a non-transitory computer-readable storage medium to another non-transitory computer-readable storage medium. For example, the computer instructions may be transmitted from a website, computer, server, or data center to another website, computer, server, or data center in a wired (for example, a coaxial cable, an optical fiber, or a digital subscriber line (DSL)) or a wireless (for example, infrared, radio, and microwave) manner. Optionally, the non-transitory computer-readable storage medium is any usable medium accessible by a computer, or a data storage device, such as a server or a data center, integrating one or more usable media. Optionally, the usable medium is a magnetic medium (for example, a floppy disk, a hard disk drive, or a magnetic tape), an optical medium (for example, a digital video disk (, DVD)), a semiconductor medium (for example, a solid state disk (SSD)), or the like.

The foregoing embodiments are merely intended to describe the solutions of the embodiments, but are not intended as limiting. Although described in detail with reference to the foregoing embodiments, a person of ordinary skill in the art should understand that modifications can still be made to the solutions described in the foregoing embodiments, or equivalent replacements can still be made to some features thereof, without departing from the of the solutions of the embodiments.

1. A method, applied to a computer device, comprising:
obtaining an input/output (I/O) command for a file system of the computer device; and
in response to the I/O command instructing to perform a modification operation on an existing file in the file system,
performing a data backup procedure on the existing file, and
modifying the existing file according to the I/O command, wherein the modification operation comprises one or more of a delete operation, a rename operation, or a write operation; and
the data backup procedure comprises:
determining whether a target process initiating the I/O command is a trusted process, wherein the trusted process is a non-malicious process known to the computer device; and
in response to if the target process being an untrusted process, performing data backup on the existing file to obtain backup data of the existing file.

2. The method according to claim 1, wherein the computer device stores a trusted process list, the trusted process list comprises a process identifier of one or more trusted processes, and determining whether the target process initiating the I/O command is the trusted process further comprises:
in response to if the trusted process list not comprising a process identifier of the target process, determining that the target process is the untrusted process.

3. The method according to claim 2, further comprising:
receiving the trusted process list sent by a management device, wherein the trusted process list is generated based on processes that have been run by multiple computer devices, and a trusted process indicated by a process identifier in the trusted process list meets that the trusted process has been run by the multiple computer devices for a quantity of times greater than a quantity-of-times threshold.

4. The method according to claim 2, wherein the computer device stores an untrusted process list, the untrusted process list comprises a process identifier of one or more untrusted processes, and determining whether the target process initiating the I/O command is the a trusted process further comprises:
in response to the untrusted process list comprising the process identifier of the target process, determining that the target process is the untrusted process; and
in response to the untrusted process list not comprising the process identifier of the target process, determining whether the trusted process list comprises the process identifier of the target process.

5. The method according to claim 4, wherein the untrusted process list comprises a process identifier of a process used for file compression and/or a process identifier of a process used to run a Java program.

6. The method according to claim 2, wherein a process identifier of a process comprises a process file path of the process and/or a process file content hash value of the process.

7. The method according to claim 1, wherein the computer device stores a file path list, the file path list comprises one or more file paths, and performing the data backup on the existing file in response to if the target process being the untrusted process further comprises:
in response to the target process being the untrusted process, and the file path list does not comprise a file path of the existing file, performing data backup on the existing file.

8. The method according to claim 7, wherein determining whether the target process initiating the I/O command is the trusted process further comprises:
in response to the file path list not comprising the file path of the existing file, determining whether the target process is the trusted process.

9. The method according to claim 1, wherein the computer device stores a file type list, the file type list comprises one or more file types, and performing the data backup on the existing file in response to the target process being the untrusted process further comprises:
in response to the target process is being the untrusted process and the file type list comprises a file type of the existing file, performing data backup on the existing file.

10. The method according to claim 9, wherein determining whether the target process initiating the I/O command is the trusted process further comprises:
in response to if the file type list comprising the file type of the existing file, determining whether the target process is the trusted process.

11. The method according to claim 1, wherein after performing the data backup on the existing file, the method further comprises:
in response to that the target process is ransomware, recovering the existing file based on the backup data of the existing file.

12. The method according to claim 11, further comprising:
sending a file behavior log of the target process to the management device, wherein the file behavior log comprises related information about an I/O operation performed by the target process on the file system within preset duration; and
receiving a determining result of the target process that is sent by the management device, wherein the determining result indicates whether the target process is ransomware.

13. The method according to claim 1, wherein a minifilter driver for the file system is installed in the computer device, a callback function is compiled in the minifilter driver, and an operating system of the computer device is configured to:
when receiving the I/O command instructing to perform the modification operation on the existing file in the file system, call the callback function to perform the data backup procedure.

14. A computer device, comprising a memory, a network interface, and at least one processor, wherein
the memory is configured to store program instructions;
after the at least one processor reads the program instructions stored in the memory, the computer device is caused to perform the following operations:
obtaining an input/output (I/O) command for a file system of the computer device; and
in response to the I/O command instructing to perform a modification operation on an existing file in the file system,
performing a data backup procedure on the existing file, and
modifying the existing file according to the I/O command, wherein the modification operation comprises one or more of a delete operation, a rename operation, or a write operation; and
the data backup procedure comprises:
determining whether a target process initiating the I/O command is a trusted process, wherein the trusted process is a non-malicious process known to the computer device; and
in response to the target process being an untrusted process, performing data backup on the existing file to obtain backup data of the existing file.

15. The computer device according to claim 14, wherein the computer device stores a trusted process list, the trusted process list comprises a process identifier of one or more trusted processes, and after the program instructions are read by the at least one processor, the computer device is caused to perform the following operations:
in response to the trusted process list not comprising a process identifier of the target process, determining that the target process is the untrusted process.

16. The computer device according to claim 15, wherein the computer device stores an untrusted process list, the untrusted process list comprises a process identifier of one or more untrusted processes, and after the program instructions are read by the at least one processor, the computer device is caused to perform the following operations:
in response to the untrusted process list comprising the process identifier of the target process, determining that the target process is the untrusted process; and
in response to the untrusted process list not comprising the process identifier of the target process, determining whether the trusted process list comprises the process identifier of the target process.

17. The computer device according to claim 14, wherein the computer device stores a file path list, the file path list comprises one or more file paths, and after the program instructions are read by the at least one processor, the computer device is caused to perform the following operations:
in response to the target process being the untrusted process, and the file path list does not comprise a file path of the existing file, performing data backup on the existing file.

18. The computer device according to claim 14, wherein the computer device stores a file type list, the file type list comprises one or more file types, and after the program instructions are read by the at least one processor, the computer device is caused to perform the following operations:
in response to the target process being the untrusted process and the file type list comprises a file type of the existing file, performing data backup on the existing file.

19. A management device, comprising a memory, a network interface, and at least one processor, wherein
the memory is configured to store program instructions;
after the at least one processor reads the program instructions stored in the memory, the management device is caused to perform the following operations:
receiving process logs sent by multiple computer devices, wherein the process log comprises a process identifier of a process that has been run by the computer device;
generating a trusted process list based on the process logs sent by the multiple computer devices, wherein the trusted process list comprises a process identifier of one or more trusted processes, and a trusted process indicated by a process identifier in the trusted process list meets that the trusted process has been run by the multiple computer devices for a quantity of times greater than a quantity-of-times threshold; and
sending the trusted process list to the multiple computer devices, wherein the trusted process list is used by the computer device to perform a data backup procedure on an existing file in a file system of the computer device.

20. The management device according to claim 19, wherein after the program instructions are read by the at least one processor, the management device is caused to further perform the following operations:
receiving a file behavior log of a target process sent by the computer device, wherein the file behavior log comprises related information about an input/output (I/O) operation performed by the target process on the file system of the computer device within preset duration;
determining, based on the related information about the I/O operation performed by the target process on the file system of the computer device within the preset duration, whether the target process is ransomware; and
sending a determining result of the target process to the computer device, wherein the determining result indicates whether the target process is ransomware.
